(19) United States
(12) Patent Application Publication
(10) Pub. No.: US 2012/0166801 A1
(43) Pub. Date: Jun. 28, 2012

(54) MUTUAL AUTHENTICATION SYSTEM AND METHOD FOR MOBILE TERMINALS

(75) Inventors: Young-Soo PARK, Daejeon-si (KR); Young-Il KIM, Daejeon-si (KR); Cheol-Hye CHO, Daejeon-si (KR); Dae-Geun PARK, Daejeon-si (KR); Yong-Su LEE, Daejeon-si (KR); Sun-Sim CHUN, Daejeon-si (KR)

(73) Assignee: Electronics and Telecommunications Research Institute, Daejeon (KR)

(21) Appl. No.: 13/335,852

(22) Filed: Dec. 22, 2011

(30) Foreign Application Priority Data
Dec. 23, 2010 (KR) 10-2010-0133796

(51) Int. Cl. H04L 9/32

(52) U.S. Cl. 713/169; 726/3

(57) ABSTRACT

Provided is a technique for mutual authentication between different kinds of objects (devices, apparatuses, users, etc.) by expanding the kinds of objects that are subject to authentication, such as authentication between users, authentication between users and an apparatuses (devices, equipment, terminals, etc.), and authentication between apparatuses (devices, equipment, terminals, etc.).

### CROSS-REFERENCE TO RELATED APPLICATION

This application claims the benefit under 35 U.S.C. §119(a) of a Korean Patent Application No. 10-2010-0133796, filed on Dec. 23, 2010, the entire disclosure of which is incorporated herein by reference for all purposes.

### BACKGROUND

1. Field

The following description relates to an authentication technique, and more particularly, to a mutual authentication system and method for mobile terminals.

2. Description of the Related Art

A bidirectional communication network requires mutual authentication between a data server (authentication server) for transmitting multimedia data (content) and receiver terminals (or users). Conventionally, as means for mutual authentication, a storage/input/output device (a smart card, a PCMCIA card, etc.) that off-line issues identification information has been used. However, the identification information that is off-line issued was updated only through reissuance which takes significant time and extra cost.

Also, IT infrastructure-based services, which deal with personal information, such as the location and identity information of users, are exposed to the potential risks of information leakage. For this reason, a demand for authentication management of various objects (devices, apparatuses, terminals, etc.) is increasing, and accordingly, a technique for mutual authentication between different kinds of objects (devices, apparatuses, users, etc.) by expanding the kinds of objects that are subject to authentication, such as authentication between users, authentication between users and apparatuses (devices, equipment, terminals, etc.), and authentication between apparatuses (devices, equipment, terminals, etc.), is necessary.

Moreover, certificate-based solutions are vulnerable to duplication since they include no hardware information with authentication information. Also, hardware-based recognition solutions have limitation in view of interworkability and security between apparatuses (devices, equipment, terminals, etc.) and users since they recognize apparatuses (devices, equipment, terminals, etc.) only with hardware information.

Meanwhile, an authentication security system, which is configured with an authentication server, a mobile terminal, etc., is widely used for security, identity authentication, etc.

In the authentication security system, the authentication server has an identification information list in which identification (ID) information, keys, and data of mobile terminals are stored, and each mobile terminal stores its own ID and key therein.

The authentication server transmits a challenge hash value together with an instruction for requesting identification information, to the mobile terminal, and the mobile terminal transmits a terminal hash value resulting from hashing the challenge hash value, its own ID, and its own key, to the authentication server.

Then, the authentication server detects an ID and key corresponding to the mobile terminal from the identification information list, based on the challenge hash value and the data and terminal hash value received from the mobile terminal. Also, the authentication server generates a challenge signal, transmits it to the mobile terminal, generates a new key to be shared with the mobile terminal using the challenge signal, and stores the new key.

However, when the terminal hash value, the challenge hash value, and the data are transmitted from the mobile terminal to the authentication server, no encryption is conducted. Accordingly, by tapping and traffic analysis, a challenge hash value and data (that is, inputs and outputs) which the authentication server has to check may leak out, resulting in leakage of the hash function through tapping and traffic analysis, so that data being transmitted from the authentication server to the mobile terminal may leak out.

### SUMMARY

The following description relates to a technique of allowing a mobile terminal, an authentication agent, and an authentication server, which are objects of an authentication security system, to perform mutual authentication using challenge so as to exchange data only between authenticated objects, thereby preventing data leakage.

The following description also relates to a method of effectively updating data stored in each object by on-line transmitting and receiving challenge signals and response signals.

The following description also relates to a technique for mutual authentication between different kinds of objects (devices, apparatuses, users, etc.) by expanding the kinds of objects that are subject to authentication, such as authentication between users, authentication between users and apparatuses (devices, equipment, terminals, etc.), and authentication between apparatuses (devices, equipment, terminals, etc.).

Therefore, since the security of data that is transmitted/received between a server for transmitting multimedia data (content) and a receiver terminal is guaranteed, security attacks such as tapping may be prevented.

The following description also relates to a method of guaranteeing safe transmission/reception of multimedia data (content).

In one general aspect, there is provided a method for mutual authentication through an authentication agent between a mobile terminal and an authentication server, including: generating a first challenge signal using first arbitrary information and transmitting the first challenge signal to the mobile terminal; receiving a first response signal generated based on information about the mobile terminal, from the mobile terminal; generating a query signal for requesting authentication of the mobile terminal and the authentication agent, and transmitting the query signal to the authentication server; receiving a second challenge signal generated based on second arbitrary information, from the authentication server; generating a second response signal based on information about the authentication agent, and transmitting the second response signal to the authentication server; receiving a first reply signal generated based on the information about the authentication agent, from the authentication server; and transmitting a second reply signal generated based on the information about the mobile terminal, to the mobile terminal.

The method further includes allocating a seed values SEED_M, a key value KEY_M, and identification information ID_M to the mobile terminal, allocating a seed value SEED_AG, a key value KEY_AG, and identification information ID_AG to the authentication agent, and then storing the seed values SEED_M and SEED_AG, the key values KEY_M and KEY_ID, and the identification information ID_M and ID_AG in the authentication server.

In the transmitting of the first challenge signal to the mobile terminal, the first challenge signal is generated with a hash value for first arbitrary information including one of a nonce value, a random number, and a time.

In the receiving of the first response signal from the mobile terminal, the information about the mobile terminal includes at least one of the first challenge signal, and a seed value SEED_M, key value KEY_M, and identification information ID_M of the mobile terminal.

In the transmitting of the query signal to the authentication server, the query signal is generated in response to the first response signal.

In the receiving of the second challenge signal, the second challenge signal is generated with a hash value for second arbitrary information including one of a nonce value, a random number, and a time.

In the transmitting of the second response signal to the authentication server, the information about the authentication agent includes at least one of the second challenge signal and a seed value SEED_AG, key value KEY_AG, and identification information ID_AG of the authentication agent.

In the transmitting of the second response signal to the authentication server, the information about the authentication agent includes at least one of the first response signal, identification information ID_M of the mobile terminal, identification information ID_AG of the authentication agent, and the second challenge signal.

The method further includes: authenticating, at the authentication server, the mobile terminal and the authentication agent in response to the second response signal; and if the authentication server determines that the mobile terminal and the authentication agent are valid, updating, at the authentication server, seed values SEED_M and SEED_AG of the mobile terminal and the authentication agent to new seed values SEED_M′ and SEED_AG′, respectively, using key values KEY_M and KEY_AG of the mobile terminal and the authentication agent.

In the receiving of the first reply signal from the authentication server, the information about the authentication agent includes at least one of a seed value SEED_M and identification information ID_M of the mobile terminal, a seed value SEED_AG and identification information ID_AG of the authentication agent, and the second response signal.

In the receiving of the first reply signal from the authentication server, the information about the authentication agent includes a seed value SEED_AG of the authentication agent and s SEED_M and a seed value SEED_M of the mobile terminal encrypted with a key value KEY_M of the mobile terminal.

In the receiving of the first reply signal from the authentication server, the information about the authentication agent includes at least one of the new seed value SEED_M′ of the mobile terminal, the identification information ID_M of the mobile terminal, the new seed value SEED_AG′ of the authentication agent, the identification information ID_AG of the authentication agent, and the second response signal.

The receiving of the first reply signal from the authentication server includes receiving encryption data generated by encrypting the information about the mobile terminal with the key value KEY_AG of the authentication agent.

The method further includes generating decryption data by decrypting the encryption data with the key value KEY_AG of the authentication agent.

The method further includes: authenticating the authentication server using the first reply signal; and updating, if it is determined that the authentication server is valid, the seed value SEED_AG of the authentication agent to the new seed value SEED_AG′.

In the transmitting of the second reply signal to the mobile terminal, the information about the mobile terminal includes at least one of the first response signal, and the seed value SEED_M, key value KEY_M and identification information ID_M of the mobile terminal.

In the transmitting of the second reply signal to the mobile terminal, the information about the mobile terminal includes at least one of a new seed value SEED_AG′ of the authentication agent, identification information ID_AG of the authentication agent, and the first response signal.

The method further includes: authenticating, at the mobile terminal, the authentication server using the second reply signal; and updating, if it is determined that the authentication server is valid, the seed value SEED_M of the mobile terminal to a new seed value SEED_M′.

In another general aspect, there is provided a system of performing mutual authentication through an authentication agent between a mobile terminal and an authentication server, wherein the authentication agent generates a first challenge signal with a hash value for first arbitrary information including one of a nonce value, a random number, and a time, transmits the first challenge signal to the mobile terminal, receives a first response signal from the mobile terminal in response to the first challenge signal, using the first response signal to generate a second response signal and a query signal for requesting authentication of the mobile terminal, and transmits the second response signal and the query signal to the authentication server, thereby mutually authenticating the mobile terminal and the authentication server, the authentication server generates, when receiving the query signal from the authentication agent, a second challenge signal with a hash value for second arbitrary information including one of a nonce value, a random value, and a time, transmits the second challenge signal to the authentication agent, receives a second response signal from the authentication agent in response to the second challenge signal, updates seed values SEED_M and SEED_AG of the mobile terminal and the authentication agent to new seed values SEED_M′ and SEED_AG′ using the second response signal to generate a first reply signal, and transmits the first reply signal to the authentication agent, thereby authenticating the mobile terminal, and the mobile terminal generates, when receiving the first challenge signal from the authentication agent, the first response signal based on information about the mobile terminal including one of the first challenge signal, and the seed value SEED_M, key value KEY_M, and identification information ID_M of the mobile terminal, transmits the first response signal to the authentication agent, updates the seed value SEED_M of the mobile terminal to a new seed value SEED_M′ using the first response signal and a second reply signal, thereby authenticating the authentication server.

The first and second challenge signals, the first and second response signals, and the first and second reply signals, which are received/transmitted between the mobile terminal, the authentication agent, and the authentication server, are generated with a hash function.

Therefore, by allowing data exchange only between authenticated objects (for example, only between an authenticated mobile terminal and an authenticated server), data leakage may be prevented.

Furthermore, since authentication between the mobile terminal and the authentication server is performed through the authentication agent, the authentication server may perform mutual authentication with a plurality of mobile terminals with relatively low load.

In addition, since recognition is conducted based on mutual authentication between users, between users and an apparatuses, or between apparatuses, the mutual authentication system may be applied to various security situations, such as entrance control, identification, key allocation, etc., for security enhancement.

Other features and aspects will be apparent from the following detailed description, the drawings, and the claims.

### BRIEF DESCRIPTION OF THE DRAWINGS

FIG. 1 is a diagram illustrating an example of a mutual authentication system.

FIG. 2 is a diagram illustrating an example of a mobile terminal that can perform mutual authentication.

FIG. 3 is a diagram illustrating an example of an authentication agent that can perform mutual authentication.

FIG. 4 is a diagram illustrating an example of an authentication server that can perform mutual authentication.

FIG. 5 is a flowchart illustrating an example of a mutual authentication method.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

The following description is provided to assist the reader in gaining a comprehensive understanding of the methods, apparatuses, and/or systems described herein. Accordingly, various changes, modifications, and equivalents of the methods, apparatuses, and/or systems described herein will be suggested to those of ordinary skill in the art. Also, descriptions of well-known functions and constructions may be omitted for increased clarity and conciseness.

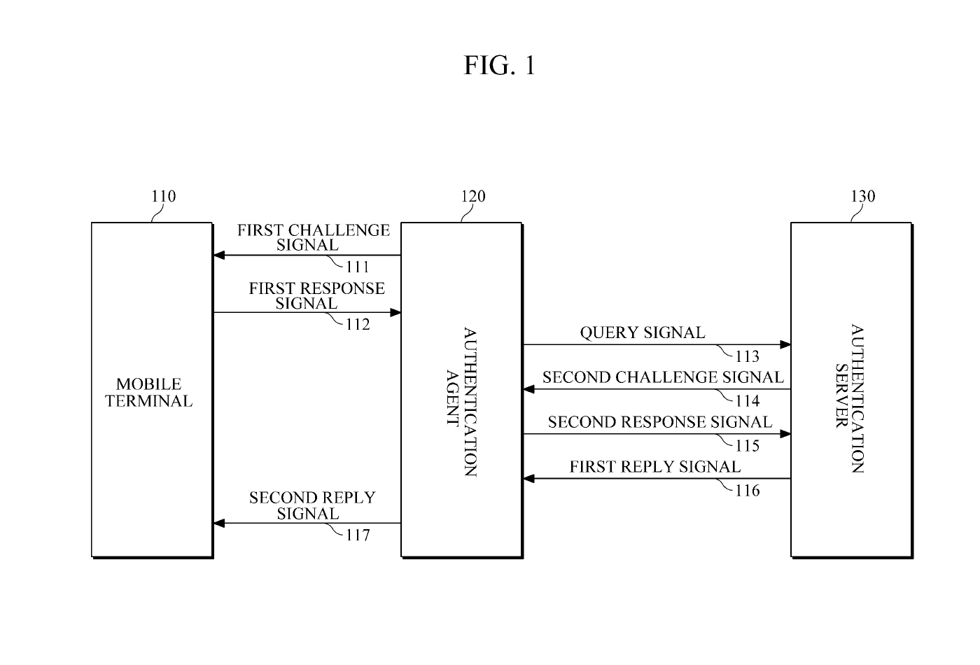

FIG. 1 is a diagram illustrating an example of a mutual authentication system.

Referring to FIG. 1, a mobile terminal 110 and an authentication agent 120 each possesses its own seed value, its own key value, and its own identification (ID) information, which are also stored in an authentication server 130.

In detail, the mobile terminal 110 stores its own seed value SEED_M, its own key value KEY_M and its own identification information ID_M, the authentication agent 120 stores its own seed value SEED_AG, its own key value KEY_AG and its own identification information ID_AG, and the authentication server 130 stores data, the seed value SEED_M, key value KEY_M and identification information ID_M of the mobile terminal 110, information about other mobile terminals, the seed value SEED_AG, key value KEY_AG and identification information ID_AG of the authentication agent 120, and information about other authentication agents.

The authentication agent 120 generates a first challenge signal and transmits it to the mobile terminal 110 (111), wherein the first challenge signal is a hash value of information (a nonce, a random number, a time, etc.) for mutual authentication, and the information is created by the authentication agent 120.

The mobile terminal 110 generates a first response signal in response to the first challenge signal and transmits the first response signal to the authentication agent 120, wherein the first response signal is generated based on at least one of the first challenge signal, and the seed value SEED_M, key value KEY_M, and identification information ID_M of the mobile terminal 110 (112).

The authentication agent 120 receives the first response signal, and transmits a query signal for requesting authentication of the authentication agent 120 and the mobile terminal 110, to the authentication server 130 (113).

The authentication server 120 generates a second challenge signal in response to the query signal, and transmits the second challenge signal to the authentication agent 120 (114), wherein the second challenge signal is a hash value of information (a nonce value, a random number, a time, etc.) for mutual authentication, and the information is generated by the authentication server 130.

The authentication agent 120 generates a second response signal using the seed value SEED_AG, key value KEY_AG, and identification information ID_AG of the authentication agent 120, and the second challenge signal. At this time, the authentication agent 120 may include at least one of the first response signal, the identification information ID_M of the mobile terminal 110, the identification information ID_AG of the authentication agent 120, and the first challenge signal, in the second response signal.

The authentication agent 120 transmits the second response signal to the authentication server 130.

Then, the authentication server 130 verifies the second response signal. In other words, the authentication server 130 authenticates the mobile terminal 110 and the authentication agent 120, using the identification information ID_M and ID_AG, seed values SEED_M and SEED_AG, and key values KEY_M and KEY_AG of the mobile terminal 110 and the authentication agent 120.

If it is determined that the mobile terminal 110 and the authentication agent 120 are valid, the authentication server 130 updates the seed values SEED_M and SEED_AG using the key values KEY_M and KEY_AG to generate new seed values SEED_M′ and SEED_AG′.

Then, the authentication server 130 uses the new seed values SEED_M′ and SEED_AG′, the identification information ID_M of the mobile terminal 110, and the identification information ID_AG of the authentication agent 120 to generate a first reply signal. That is, the first reply signal may be generated based on the identification information ID_M of the mobile terminal 110 and the seed value SEED_M of the mobile terminal 110 encrypted with the key value KEY_M of the mobile terminal 110.

Also, the authentication server 130 generates encryption data EDATA-KEY_AG by encrypting data about the mobile terminal 110 with the key value KEY_AG of the authentication agent 120.

The authentication server 120 transmits the first reply signal and the encryption data EDATA-KEY_AG to the authentication agent 120 (116).

That is, the authentication agent 120 receives the first reply signal and the encryption data EDATA-KEY_AG from the authentication server 130, in response to the second response signal, wherein the first reply signal is generated based on the result of the authentication on the authentication agent 120 and the mobile terminal 110 (116). Then, the authentication agent 120 authenticates the authentication server 130 based on the first reply signal.

If the authentication agent 120 determines that the authentication server 130 is valid, the authentication agent 120 decrypts the encryption data EDATA-KEY_AG using the key value KEY_AG of the authentication agent 120, thus obtaining decryption data DATA.

The authentication agent 120 calculates a new key value KEY_AG′, and updates the seed value SEED_AG and the key value KEY_AG to the new seed value SEED_AG′ and the new key value KEY_AG′, respectively, for authentication. Then, the authentication agent 120 transmits a second reply signal to the mobile terminal 110 (117).

Successively, the mobile terminal 110 calculates a new seed value SEED_M′ using the second reply signal, and authenticates the authentication server 130.

If the mobile terminal 110 determines that the authentication server 130 is valid, the mobile terminal 110 calculates a new key value KEY_M′, and updates the seed value SEED_M and the key value KEY_M to the seed value SEED_M′ and the key value KEY_M′, respectively, thereby terminating the authentication process.

If there are a plurality of mobile terminals, the process as described above is repeated by the number of the mobile terminals, starting from the operation 111.

Also, the mobile terminal, the authentication agent, and the authentication server may transmit/receive the challenge/response/reply signals using a hash function, and perform data encryption and decryption using XOR (exclusive or) operation or a secret-key algorithm (DES, 3DES, AES, etc.).

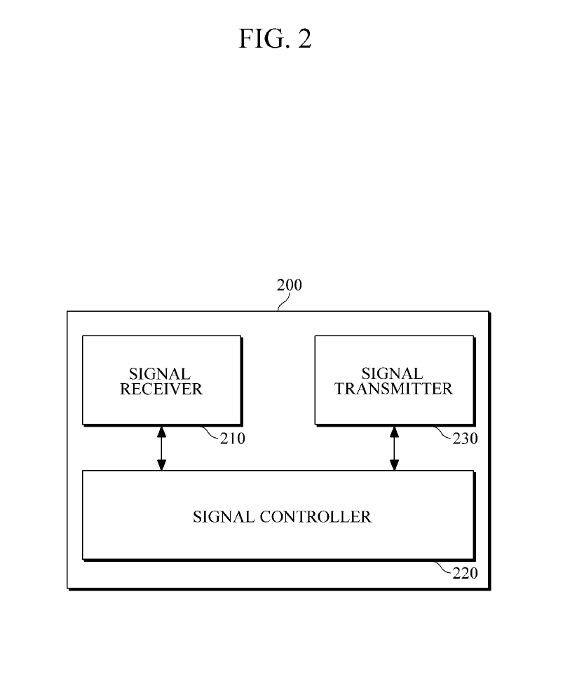

FIG. 2 is a diagram illustrating an example of a mobile terminal 200 that can perform mutual authentication. Referring to FIG. 2, the mobile terminal 200 may include a signal receiver 210, a signal controller 220, and a signal transmitter 230.

The signal receiver 210 receives a first challenge signal from an authentication agent.

The signal controller 220 generates a first response signal in response to the first challenge signal, based on at least one of the first challenge signal, and a seed value SEED_M, key value KEY_M, and identification information ID_M of the mobile terminal 200, and transmits the first response signal to an authentication agent in order to authenticate an authentication server.

If the mobile terminal 200 determines that the authentication server is valid, the signal controller 220 updates the seed value SEED_M and key value KEY_M of the mobile terminal 200.

That is, the mobile terminal 200 which has received the first challenge signal generates the first response signal, based on information about the mobile terminal 200, including at least one of the first challenge signal, and the seed value SEED_M, key value KEY_M, and identification information ID_M of the mobile terminal 200, transmits the first response signal to the authentication agent, and updates the seed value SEED_M of the mobile terminal 200 to a new seed value SEED_M′ using the first response signal and a second reply signal, thereby authenticating the authentication server.

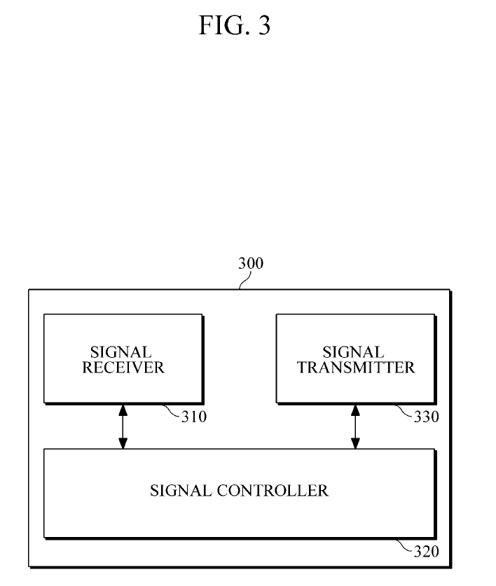

FIG. 3 is a diagram illustrating an example of an authentication agent 300 that can perform mutual authentication. Referring to FIG. 3, the authentication agent 300 may include a signal receiver 310, a signal controller 320, and a signal transmitter 330.

The signal controller 320 generates a first challenge signal, and the signal transmitter 330 transmits the first challenge signal to a mobile terminal. Then, the signal receiver 310 receives a first response signal from the mobile terminal in response to the first challenge signal, wherein the first response signal has been generated based on at least one of the first challenge signal, and a seed value SEED_M, key value KEY_M, and identification information ID_M of the mobile terminal.

For example, the signal receiver 310 may receive a first response signal including identification information ID_M of the mobile terminal, from the mobile terminal.

Then, the signal transmitter 330 transmits a query signal for requesting authentication of the authentication agent 300 and the mobile terminal to the authentication server. The signal receiver 310 may receive a second challenge signal from the authentication server in response to the query signal, and the signal controller 320 may generate a second response signal based on at least one of the second challenge signal, and a seed value SEED_AG, key value KEY_AG, and identification information ID_AG of the authentication agent 300. The signal transmitter 330 transmits the second response signal to the authentication server, and the signal receiver 310 receives a first reply signal from the authentication server in response to the second response signal, wherein the first reply signal has been generated based on the result of the authentication on the authentication agent 300 and the mobile terminal.

At this time, the signal receiver 310 may receive encryption data EDATA-KEY_AG obtained by encrypting data about the mobile terminal with the key value KEY_M of the authentication agent 300, together with the first reply signal.

In detail, the first reply signal may be generated based on identification information ID_AG of the authentication agent 300 and the seed value SEED_AG of the authentication agent 300 encrypted with the key value KEY_AG of the authentication agent 300.

Or, the first reply signal may be generated based on identification information ID_M of the mobile terminal and the seed value SEED_M of the mobile terminal encrypted with the key value KEY_M of the mobile terminal.

Then, the signal controller 320 may authenticate the authentication server based on the first reply signal.

At this time, the signal controller 320 may generate a second response signal including at least one of the first response signal, the identification information ID_M of the mobile terminal, the identification information ID_AG for the authentication agent, and the first challenge signal.

Also, if it is determined that the authentication server is valid, the signal controller 320 decrypts the encryption data EDATA_KEY_AG with the key value KEY_AG of the authentication agent 300, thereby acquiring data DATA.

Then, the signal controller 320 may update the key value KEY_AG of the authentication agent 300 using the first reply signal and the key value KEY_AG of the authentication agent 300.

The signal controller 320 may transmit the first reply signal related to the mobile terminal to the mobile terminal in order for the mobile terminal to authenticate the authentication server.

If the mobile terminal determines that the authentication server is valid, the signal controller 320 may update the seed value SEED_M and key value KEY_M of the mobile terminal.

That is, the authentication agent 300 generates a first challenge signal with a hash value for information including one of a nonce value, a random number, and a time, transmits the first challenge signal to the mobile terminal, receives a first response signal from the mobile terminal in response to the first challenge signal, generates a query signal for requesting authentication of the mobile terminal and a second response signal using the first response signal, and transmits the query signal and the second response signal to the authentication server, thereby mutually authenticating the mobile terminal and the authentication server.

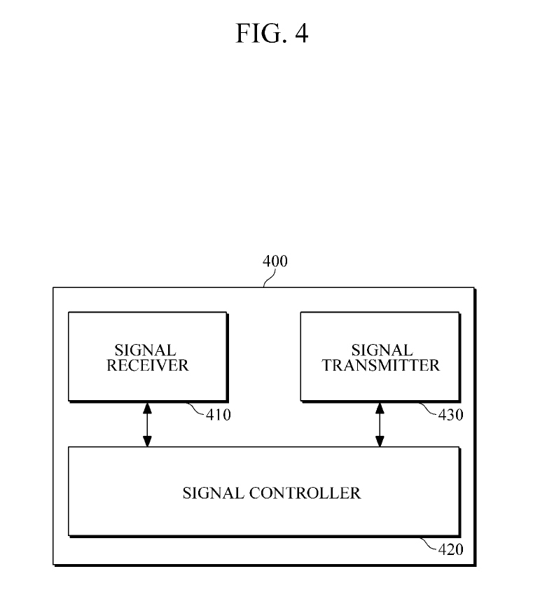

FIG. 4 is a diagram illustrating an example of an authentication server 400 that can perform mutual authentication. Referring to FIG. 4, the authentication server 400 may include a signal receiver 410, a signal controller 420, and a signal transmitter 430.

The signal receiver 410 receives a query signal for requesting authentication of an authentication agent and a mobile terminal, from the authentication agent.

Then, the signal controller 420 generates a second challenge signal in response to the query signal, and the signal transmitter 430 transmits the second challenge signal to the authentication agent.

Thereafter, the signal receiver 410 receives a second response signal from the authentication agent, in response to the second challenge signal, wherein the second response signal has been generated based on at least one of the second challenge signal, and a seed value SEED_AG, key value KEY_AG, and identification information ID_AG of the authentication agent.

Then, the signal controller 420 controls the signal transmitter 430 to transmit a first reply signal to the authentication agent, in response to the second response signal, wherein the first reply signal is generated based on the result of authentication on the authentication agent and the mobile terminal.

Also, the signal controller 420 controls the signal transmitter 430 to transmit, to the authentication agent, the first reply signal together with encryption data EDATA-KEY_AG resulting from encrypting data about the mobile terminal with the key value KEY_AG of the authentication agent, so that the authentication agent can authenticate the authentication server 400 based on the first reply signal.

At this time, the first reply signal may be generated based on identification information ID_AG of the authentication agent and the seed value SEED_AG of the authentication agent encrypted with the key value KEY_AG of the authentication agent.

Also, when receiving the query signal from the authentication agent, the authentication server 400 generates the second challenge signal with a hash value for information including one of a nonce value, a random number, and a time, transmits the second challenge signal to the authentication agent, receives the second response signal from the authentication agent in response to the second challenge signal, updates the seed values SEED_M and SEED_AG of the mobile terminal and the authentication agent to new seed values SEED_M′ and SEED_AG′ to generate the first reply signal, and transmits the first reply signal to the authentication agent, thereby authenticating the mobile terminal.

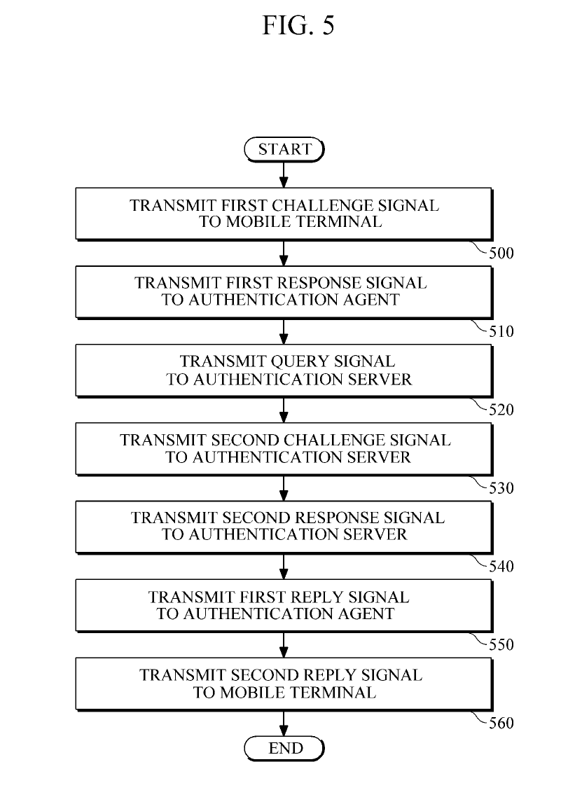

FIG. 5 is a flowchart illustrating an example of a mutual authentication method.

FIG. 5 relates to a method in which mutual authentication between a mobile terminal and an authentication server is performed through an authentication agent.

First, the authentication agent generates a first challenge signal using first arbitrary information and transmits the first challenge signal to the mobile terminal (500).

Then, the mobile terminal generates a first response signal based on its own information, and transmits the first response signal to the authentication agent (510). The authentication agent transmits a query signal for requesting authentication of the mobile terminal and the authentication agent, to the authentication server (520).

Thereafter, the authentication sever generates a second challenge signal using second arbitrary information, and transmits the second challenge signal to the authentication agent (530).

Then, the authentication agent generates a second response signal based on its own information, and transmits the second response signal to the authentication server (540).

Successively, the authentication server generates a first reply signal based on the information about the authentication agent, and transmits the first reply signal to the authentication agent (550). Then, the authentication agent generates a second reply signal based on the information about the mobile terminal, and transmits the second reply signal to the mobile terminal (560).

If the authentication server authenticates the mobile terminal and the authentication agent using the second response signal and determines that the mobile terminal and the authentication agent are valid, the authentication server may update seed values SEED_M and SEED_AG of the mobile terminal and the authentication agent to new seed values SEED_M′ and SEED_AG′ using their key values KEY_M and KEY_AG.

In addition, the authentication agent decrypts encryption data using the key value KEY_AG of the authentication agent to generate decryption data.

The present invention can be implemented as computer readable codes in a computer readable record medium. The computer readable record medium includes all types of record media in which computer readable data are stored. Examples of the computer readable record medium include a ROM, a RAM, a CD-ROM, a magnetic tape, a floppy disk, and an optical data storage. Further, the record medium may be implemented in the form of a carrier wave such as Internet transmission. In addition, the computer readable record medium may be distributed to computer systems over a network, in which computer readable codes may be stored and executed in a distributed manner.

A number of examples have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A method for mutual authentication through an authentication agent between a mobile terminal and an authentication server, comprising:
generating a first challenge signal using first arbitrary information and transmitting the first challenge signal to the mobile terminal;
receiving a first response signal generated based on information about the mobile terminal, from the mobile terminal;
generating a query signal for requesting authentication of the mobile terminal and the authentication agent, and transmitting the query signal to the authentication server;
receiving a second challenge signal generated based on second arbitrary information, from the authentication server;
generating a second response signal based on information about the authentication agent, and transmitting the second response signal to the authentication server;
receiving a first reply signal generated based on the information about the authentication agent, from the authentication server; and
transmitting a second reply signal generated based on the information about the mobile terminal, to the mobile terminal.

2. The method of claim 1, further comprising allocating a seed values SEED_M, a key value KEY_M, and identification information ID_M to the mobile terminal, allocating a seed value SEED_AG, a key value KEY_AG, and identification information ID_AG to the authentication agent, and then storing the seed values SEED_M and SEED_AG, the key values KEY_M and KEY_ID, and the identification information ID_M and ID_AG in the authentication server.

3. The method of claim 1, wherein in the transmitting of the first challenge signal to the mobile terminal, the first challenge signal is generated with a hash value for first arbitrary information including one of a nonce value, a random number, and a time.

4. The method of claim 1, wherein in the receiving of the first response signal from the mobile terminal, the information about the mobile terminal includes at least one of the first challenge signal, and a seed value SEED_M, key value KEY_M, and identification information IDM of the mobile terminal.

5. The method of claim 1, wherein in the transmitting of the query signal to the authentication server, the query signal is generated in response to the first response signal.

6. The method of claim 1, wherein in the receiving of the second challenge signal, the second challenge signal is generated with a hash value for second arbitrary information including one of a nonce value, a random number, and a time.

7. The method of claim 1, wherein in the transmitting of the second response signal to the authentication server, the information about the authentication agent includes at least one of the second challenge signal and a seed value SEED_AG, key value KEY_AG, and identification information ID_AG of the authentication agent.

8. The method of claim 1, wherein in the transmitting of the second response signal to the authentication server, the information about the authentication agent includes at least one of the first response signal, identification information ID_M of the mobile terminal, identification information ID_AG of the authentication agent, and the second challenge signal.

9. The method of claim 7, further comprising:
authenticating, at the authentication server, the mobile terminal and the authentication agent in response to the second response signal; and
if the authentication server determines that the mobile terminal and the authentication agent are valid, updating, at the authentication server, seed values SEED_M and SEED_AG of the mobile terminal and the authentication agent to new seed values SEED_M′ and SEED_AG′, respectively, using key values KEY_M and KEY_AG of the mobile terminal and the authentication agent.

10. The method of claim 1, wherein in the receiving of the first reply signal from the authentication server, the information about the authentication agent includes at least one of a seed value SEED_M and identification information ID_M of the mobile terminal, a seed value SEED_AG and identification information ID_AG of the authentication agent, and the second response signal.

11. The method of claim 1, wherein in the receiving of the first reply signal from the authentication server, the information about the authentication agent includes a seed value SEED_AG of the authentication agent and s SEED_M and a seed value SEED_M of the mobile terminal encrypted with a key value KEY_M of the mobile terminal.

12. The method of claim 9, wherein in the receiving of the first reply signal from the authentication server, the information about the authentication agent includes at least one of the new seed value SEED_M′ of the mobile terminal, the identification information ID_M of the mobile terminal, the new seed value SEED_AG′ of the authentication agent, the identification information ID_AG of the authentication agent, and the second response signal.

13. The method of claim 10, wherein the receiving of the first reply signal from the authentication server comprises receiving encryption data generated by encrypting the information about the mobile terminal with the key value KEY_AG of the authentication agent.

14. The method of claim 13, further comprising generating decryption data by decrypting the encryption data with the key value KEY_AG of the authentication agent.

15. The method of claim 10, further comprising:
authenticating the authentication server using the first reply signal; and
updating, if it is determined that the authentication server is valid, the seed value SEED_AG of the authentication agent to the new seed value SEED_AG′.

16. The method of claim 1, wherein in the transmitting of the second reply signal to the mobile terminal, the information about the mobile terminal includes at least one of the first response signal, and the seed value SEED_M, key value KEY_M and identification information ID_M of the mobile terminal.

17. The method of claim 1, wherein in the transmitting of the second reply signal to the mobile terminal, the information about the mobile terminal includes at least one of a new seed value SEED_AG′ of the authentication agent, identification information ID_AG of the authentication agent, and the first response signal.

18. The method of claim 16, further comprising:
authenticating, at the mobile terminal, the authentication server using the second reply signal; and
updating, if it is determined that the authentication server is valid, the seed value SEED_M of the mobile terminal to a new seed value SEED_M′.

19. A system of performing mutual authentication through an authentication agent between a mobile terminal and an authentication server, wherein the authentication agent generates a first challenge signal with a hash value for first arbitrary information including one of a nonce value, a random number, and a time, transmits the first challenge signal to the mobile terminal, receives a first response signal from the mobile terminal in response to the first challenge signal, using the first response signal to generate a second response signal and a query signal for requesting authentication of the mobile terminal, and transmits the second response signal and the query signal to the authentication server, thereby mutually authenticating the mobile terminal and the authentication server,
the authentication server generates, when receiving the query signal from the authentication agent, a second challenge signal with a hash value for second arbitrary information including one of a nonce value, a random value, and a time, transmits the second challenge signal to the authentication agent, receives a second response signal from the authentication agent in response to the second challenge signal, updates seed values SEED_M and SEED_AG of the mobile terminal and the authentication agent to new seed values SEED_M′ and SEED_AG′ using the second response signal to generate a first reply signal, and transmits the first reply signal to the authentication agent, thereby authenticating the mobile terminal, and
the mobile terminal generates, when receiving the first challenge signal from the authentication agent, the first response signal based on information about the mobile terminal including one of the first challenge signal, and the seed value SEED_M, key value KEY_M, and identification information IDM of the mobile terminal, transmits the first response signal to the authentication agent, updates the seed value SEED_M of the mobile terminal to a new seed value SEED_M′ using the first response signal and a second reply signal, thereby authenticating the authentication server.

20. The method of claim 19, wherein the first and second challenge signals, the first and second response signals, and the first and second reply signals, which are received/transmitted between the mobile terminal, the authentication agent, and the authentication server, are generated with a hash function.
